(19) United States
(12) Patent Application Publication
(10) Pub. No.: US 2007/0027777 A1
(43) Pub. Date: Feb. 1, 2007

(54) Purchase order management method and system

(75) Inventor: Wen-Yi Chang, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/312,992

(22) Filed: Dec. 19, 2005

(30) Foreign Application Priority Data
Jul. 29, 2005 (TW) 94125730

(51) Int. Cl. G06Q 30/00

(52) U.S. Cl. 705/26

(57) ABSTRACT

A purchase order management method and system is proposed, which is designed for use in conjunction with a network system for providing a purchase order management function, and which is characterized by the capability of allowing the customer to follow a predefined consolidation rule to specifies a number of localities and a plurality of recipients associated with each of the localities, so that if the customer wants to request the merging of multiple batches of products into a single batch for shipment, the related recipient data can be retrieved from the database for generating a recipient grouping code based on the consolidation rule and filled into the electronic purchase order for downloading to the manufacturer, thus requesting the manufacturer to pack and ship the ordered products accordingly. This feature can help enhance the overall efficiency of OEM/ODM business transaction between the customer and the manufacturer.

### BACKGROUND OF THE INVENTION

1. Field of the Invention

This invention relates to information technology (IT), and more particularly, to a purchase order management method and system which is designed for use in conjunction with a network system for providing a manufacturer and a customer with a purchase order management function for the OEM/ODM (Original Equipment Manufacture & Original Design Manufacture) business transactions between the manufacture and the customer.

2. Description of Related Art

In the business world of OEM/ODM (Original Equipment Manufacture & Original Design Manufacture), it is a common practice by the customer to request the manufacturer to pack multiple batches of products that are to be shipped to the same destination into a single batch, so that these multiple batches of products can undergo the exportation and custom procedure just once, without undergoing multiple procedures. This practice can significantly save time and cost in the shipment of products to the customer.

In the information age, the business transactions nowadays between the customer and the manufacturer are mostly based on EDI (Electronic Data Exchange) systems. For example, when the customer wants to send a purchase order to the manufacturer, the customer will utilize the EDI system to send an EDI850 electronic purchase order via a network system to the manufacturer. Therefore, if the customer wants to combine multiple batches of products into one batch during the shipment, the customer will have to specify such a request in the EDI850 electronic purchase order that tells which batches of products are to be combined and the destination thereof.

For the above-mentioned OEM/ODM business relationship, the customer and the manufacturer will predefine and establish a consolidation rule as follows:

| AREA | CODE |
|---|---|
| NA (North America) | CustomerID + PostalCode |
| AP (Asia Pacific) | Cty + Box Sort + CTO |
| LA (Los Angles) | CTO |
| EMEA (Europe, the Middle East, | Duty + CTO |
| and Africa) | |

Taking the area NA as example, if the customer requests that multiple batches of products be merged into one batch for shipment to a certain recipient located within a certain district area in North America, the customer needs to specify the postal code (i.e., PostalCode) and the customer ID number (i.e., CustomerID) of the recipient in the EDI850 electronic purchase order, and then send the EDI-850 electronic purchase order to the manufacturer, whereby the manufacturer can handle the shipment of the ordered products in accordance with the EDI850 electronic purchase order.

One drawback to the foregoing practice, however, is that the above-listed consolidation rule is only suited for use in the case that only one recipient is located in the same destination of shipment; and if two or more recipients reside in the same destination, it would require a change to the above-listed consolidation rule. Each change of management operation procedure, however, would require the modification of the related computer program code of the computer-based OEM/ODM management system on the manufacturer side. Since the modification of the computer code is quite time-consuming, typically requires one week to complete, it would apparently consume additional human power and working hours on the manufacturer side and degrade the overall efficiency of the OEM/ODM business transaction.

### SUMMARY OF THE INVENTION

It is therefore an objective of this invention to provide a purchase order management method and system which allows the manufacturer to be unnecessary to modify the compute code of the manufacturer-owned OEM/ODM management system in the event of a change by the customer to the consolidation rule.

It is another objective of this invention to provide a purchase order management method and system which can help enhance the overall efficiency of OEM/ODM business transaction between a customer and a manufacturer.

The purchase order management method and system according to the invention is designed for use in conjunction with a network system for providing a manufacturer and a customer with a purchase order management function for the OEM/ODM (Original Equipment Manufacture & Original Design Manufacture) business transactions between the manufacture and the customer.

The purchase order management method and system according to the invention is characterized by the capability of building a database which is used to prestore a consolidation rule that specifies a number of localities and a plurality of recipients associated with each of the localities; and during actual operation, if the customer wants to request the merging of multiple batches of products into a single batch for shipment, the related recipient data can be retrieved from the database for generating a recipient grouping code based on the consolidation rule and filled into the electronic purchase order for downloading to the manufacturer, thus requesting the manufacturer to merge the specified batches of products in accordance with the recipient grouping codes and shipment date specified in the received electronic purchase order for shipment of these multiple batches of products in a single batch. This feature allows the manufacturer to be unnecessary to modify the compute code of the manufacturer-owned OEM/ODM management system in the event of a change by the customer to the consolidation rule, and also can help enhance the overall efficiency of OEM/ODM business transaction between a customer and a manufacturer.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the application and system architecture of the purchase order management system according to the invention; and

FIG. 2 is a schematic diagram showing an example of the data structure of a database module utilized by the purchase order management system of the invention.

### DETAILED DESCRIPTION OF PREFERRED EMBODIMENTS

The purchase order management method and system according to the invention is disclosed in full details by way of preferred embodiments in the following with reference to the accompanying drawings.

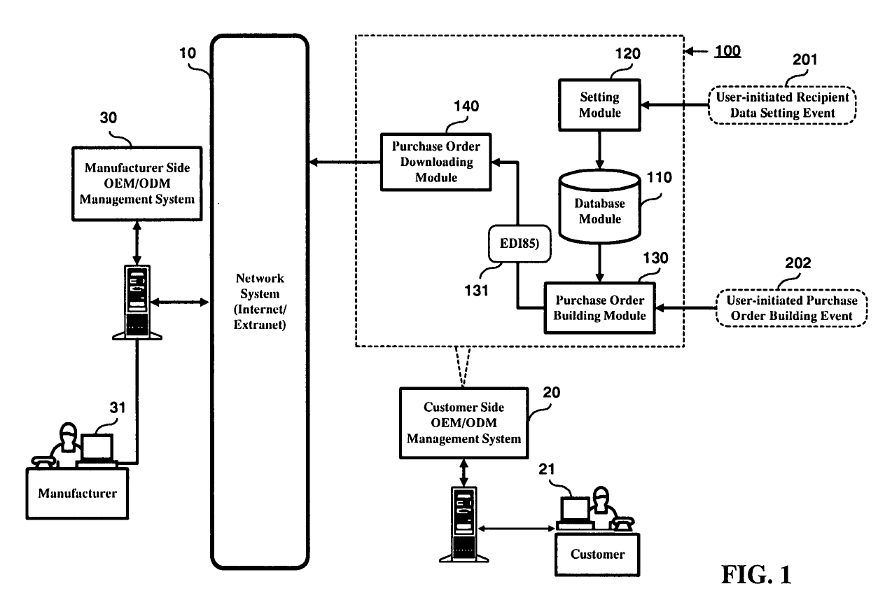

FIG. 1 is a schematic diagram showing the application and modularized system architecture of the purchase order management system according to the invention (as the part enclosed in the dotted box indicated by the reference numeral 100). As shown, the purchase order management system of the invention 100 is designed for use in conjunction with a network system 10, such as Internet, an extranet system, or the like, for providing a manufacturer and a customer with a purchase order management function for the OEM/ODM (Original Equipment Manufacture & Original Design Manufacture) business transactions between the manufacture and the customer.

In practical implementation, for example, the purchase order management system of the invention 100 can be fully realized by a set of computer code which is integrated as an add-on software module to a server-based customer-owned OEM/ODM management system 20, for the purpose of allowing the customer to utilize a customer-side network workstation 21 to send OEM/ODM orders in electronic form over the network system 10 to a manufacturer-owned OEM/ODM management system 30 on the manufacturer side, allowing the manufacturer to handle the OEM/ODM orders via a manufacturer-side network workstation 31.

As shown in FIG. 1, the modularized object-oriented component model of the purchase order management system of the invention 100 comprises: (a) a database module 110; (b) a setting module 120; (c) a purchase order building module 130; and (d) a purchase order downloading module 140.

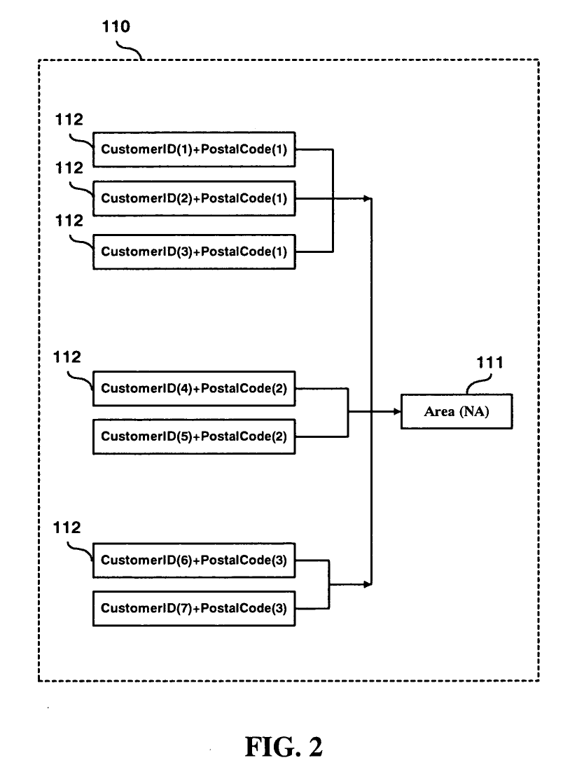

The database module 110 is used to prestore a table of multiple recipients within various localities 111, where these localities 111 are respectively designated, for example, by “NA” representative of North America, “AP” representative of Asia Pacific, “LA” representative of Los Angels, “EMEA” representative of Europe, the Middle East, and Africa, and so on, and where the recipient data 112 in relation to each locality 111 are predefined in accordance with a standard consolidation rule stipulated by the customer. For example, the table of FIG. 2 shows that in the NA locality 111, the district area with the postal code PostalCode(1) resides 3 different recipients, whose ID codes are respectively CustomerID(1), CustomerID(2), and CustomerID(3); the district area with the postal code PostalCode(2) resides 2 different recipients, whose ID codes are respectively CustomerID(4), and CustomerID(5); and the district area with the postal code PostalCode(3) resides 2 different recipients, whose ID codes are respectively CustomerID(6) and CustomerID(7).

The setting module 120 is capable of responding to a user-initiated recipient data setting event 201 on the customer-side network workstation 21 by setting or updating the data about the locality 111 and the related recipient data 112 in the database module 110.

The purchase order building module 130 is used to allow the customer to build an electronic purchase order, such as an EDI850 electronic purchase order in compliance with the EDI (Electronic Data Exchange) standard. In operation, the setting module 120 is capable of responding to a user-initiated purchase order building event 202 by building an electronic purchase order 131, wherein the electronic purchase order 131 should include at least the information about each batch of products and one customer-designated recipient to receive that batch of products; and which in the event that the customer requests the merging of that batch of products with at least one other batch of products into a single batch for shipment, is capable of retrieving related recipient data from the database module 110 under customer control for generating a recipient grouping code based on the customer-stipulated consolidation rule and filling the recipient grouping code into the electronic purchase order 131. For example, if the customer wants to designate the shipment of three batches of products to three recipients whose ID codes are respectively CustomerID(1), CustomerID(2), and CustomerID(3), and if the customer wants these three batches of products to be combined into one single batch for shipment to the area with the postal code PostalCode(1), then the customer can simply fill the data of the postal code PostalCode(1) into the electronic purchase order 131 to serve as a recipient grouping code for all of these three different recipients.

In another example, if the customer wants to designate the shipment of three batches of products to three recipients whose ID codes are respectively CustomerID(1), CustomerID(2), and CustomerID(4), and if the customer wants these three batches of products to be combined into one single batch for shipment to the area with the postal code PostalCode(1) and the postal code PostalCode(2), then the customer can simply fill the data of the locality 111 into the electronic purchase order 131 to serve as a recipient grouping code for all of these three different recipients

In still another example, if the customer wants to designate the shipment of multiple batches of products to one single recipient whose ID code is CustomerID(6), and if the customer wants these batches of products to be combined into one single batch for shipment to this recipient, then the customer can simply fill the data of the recipient's CustomerID(6) and/or PostalCode(3) into the multiple electronic purchase orders 131 associated with these multiple batches of products to serve as a recipient grouping code for the recipient and the multiple batches of products.

It can be learned from the foregoing description that the recipient grouping code can be dynamically designated in accordance with the customer-stipulated consolidation rule. In other words, when the consolidation rule of a certain locality (i.e., NA, AP, LA, or EMEA), the recipient data about the multiple recipients and their associated recipient grouping codes can be dynamically updated. On the manufacturer side, the manufacturer needs just to respond to the customer's request for shipment by looking at the data of recipient grouping codes in the electronic purchase order 131 downloaded to the manufacturer-owned OEM/ODM management system 30.

The purchase order downloading module 140 is capable of downloading the electronic purchase order 131 generated by the purchase order building module 130 via the network system 10 to the manufacture's network workstation 31, so as to request the manufacturer to produce the requested batches of products and merge these batches of products in accordance with the recipient grouping codes specified in the received electronic purchase order 131 for shipment to the customer-designated recipient(s).

In actual application, as shown in FIG. 1 and FIG. 2, the customer can first utilize the setting module 120 to specify a set of recipient data 112 for each group of multiple recipients residing within the same locality 111. The recipient data 112 are then stored into the database module 110.

In the following example of a practical application of the invention, it is assumed that the customer wants to designate the shipment of three batches of products to three recipients whose ID codes are respectively CustomerID(1), CustomerID(2), and CustomerID(3) and the customer wants these three batches of products to be combined into one single batch for shipment to the area with the postal code PostalCode(1), then the customer can simply utilize the customer-side network workstation 21 to activate the purchase order management system of the invention 100, and then use the purchase order building module 130 to build an EDI850 electronic purchase order 131 for each recipient, where the electronic purchase order 131 should include at least the information about each batch of products and a customer-designated recipient to receive that batch of products. The customer can find the data of the Postalcode(1) indicative of the area where the three recipients CustomerID(1), CustomerID(2), and CustomerID(3) reside, and then fill the data of the postal code PostalCode(1) into the electronic purchase order 131 to serve as a recipient grouping code for all of these three different recipients. Next, the purchase order downloading module 140 is activated to download each EDI850 electronic purchase order 131 over the network system 10 to the manufacturer-side network workstation 31, so as to request the manufacturer to produce the requested batches of products and merge these batches of products in accordance with the recipient grouping codes specified in the received electronic purchase order 131 for shipment to the customer-designated three recipients.

Furthermore, the purchase order management system of the invention 100 also allows the customer to update the consolidation rule for each locality 111 dynamically in accordance with present situations, i.e., the customer can utilize the setting module 120 to update the recipient data 112 in the database module 110, so as to subsequently allow the building of new electronic purchase order 131 to be based on the newly-updated recipient data 112 to obtain a recipient grouping code. On the manufacturer side, the manufacturer needs just to respond to the customer's request for shipment by looking at the data of recipient grouping codes in the electronic purchase order 131 downloaded to the manufacturer-owned OEM/ODM management system 30. This feature can significantly increase the overall efficiency in the OEM/ODM business transactions between the manufacture and the customer.

In conclusion, the invention provides a purchase order management method and system for use with a network system for providing a manufacturer and a customer with a purchase order management function, and which is characterized by the capability of building a database which is used to prestore a consolidation rule that specifies a number of localities and a plurality of recipients associated with each of the localities; and during actual operation, if the customer wants to request the merging of multiple batches of products into a single batch for shipment, the related recipient data can be retrieved from the database for generating a recipient grouping code based on the consolidation rule and filled into the electronic purchase order for downloading to the manufacturer, thus requesting the manufacturer to merge the specified batches of products in accordance with the recipient grouping codes and shipment date specified in the received electronic purchase order for shipment of these multiple batches of products in a single batch. This feature allows the manufacturer to be unnecessary to modify the compute code of the manufacturer-owned OEM/ODM management system in the event of a change by the customer to the consolidation rule, and also can help enhance the overall efficiency of OEM/ODM business transaction between a customer and a manufacturer. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A purchase order management method for use on a network system for providing a manufacturer and a customer with a purchase order management function;
the purchase order management method comprising:
on the customer side, building a database which is used to prestore a consolidation rule that specifies a number of localities and a plurality of recipients associated with each of the localities;
during actual operation, responding to a user-initiated purchase order building event by building an electronic purchase order, wherein the electronic purchase order includes at least the information about each batch of products and a customer-designated recipient to receive that batch of products; and which in the event that the customer requests the merging of that batch of products with at least one other batch of products into a single batch for shipment, is capable of retrieving related recipient data from the database under customer control for generating a recipient grouping code based on the consolidation rule and filling the recipient grouping code into the electronic purchase order; and
downloading the electronic purchase order generated via the network system to the manufacture's network workstation.

2. The purchase order management method of claim 1, further comprising:
when the electronic purchase order has been downloaded to the manufacturer, the manufacturer merges a number of batches of products in accordance with the recipient grouping codes and shipment date specified in the received electronic purchase order for shipment of these multiple batches of products in a single batch.

3. The purchase order management method of claim 1, wherein the network system includes Internet.

4. The purchase order management method of claim 1, wherein the database module network system includes an extranet system.

5. The purchase order management method of claim 1, wherein the electronic purchase order is EDI (Electronic Data Interchange) compliant in the form of EDI850.

6. A purchase order management system for use with a network system for providing a manufacturer and a customer with a purchase order management function;
the purchase order management system comprising:
a database module, which is used to prestore a consolidation rule that specifies a number of localities and a plurality of recipients associated with each of the localities;
a setting module, which is capable of responding to a user-initiated recipient data setting event by receiving a set of recipient data, and which is capable of organizing the received recipient data in accordance with a predefined consolidation rule into a number of groups, each group relating to one locality, and storing the organized recipient data into the database module;
a purchase order building module, which is capable of responding to a user-initiated purchase order building event by building an electronic purchase order, wherein the electronic purchase order includes at least the information about each batch of products and a customer-designated recipient to receive that batch of products; and which in the event that the customer requests the merging of that batch of products with at least one other batch of products into a single batch for shipment, is capable of retrieving related recipient data from the database module under customer control for generating a recipient grouping code based on the consolidation rule and filling the recipient grouping code into the electronic purchase order; and
a purchase order downloading module, which is capable of downloading the electronic purchase order generated by the purchase order building module via the network system to the manufacture's network workstation.

7. The purchase order management system of claim 6, further comprising:
when the electronic purchase order has been downloaded to the manufacturer, the manufacturer merges a number of batches of products in accordance with the recipient grouping codes and shipment date specified in the received electronic purchase order for shipment of these multiple batches of products in a single batch.

8. The purchase order management system of claim 6, wherein the network system includes Internet.

9. The purchase order management system of claim 6, wherein the database module network system includes an extranet system.

10. The purchase order management system of claim 6, wherein the electronic purchase order generated by the purchase order building module is EDI (Electronic Data Interchange) compliant in the form of EDI850.
